(19) United States
(12) Patent Application Publication
(10) Pub. No.: US 2024/0334274 A1
(43) Pub. Date: Oct. 3, 2024

(54) METHOD AND APPARATUS FOR NEIGHBOURING CELL MEASUREMENT

(71) Applicant: SPREADTRUM COMMUNICATIONS (SHANGHAI) CO., LTD., Shanghai (CN)

(72) Inventor: Yun DENG, Shanghai (CN)

(21) Appl. No.: 18/293,527

(22) PCT Filed: Sep. 18, 2021
(86) PCT No.: PCT/CN2021/119357

§ 371 Date: Jan. 30, 2024

(30) Foreign Application Priority Data
Jul. 30, 2021 (CN) 202110878081.5

(51) Int. Cl. H04W 36/00; H04W 76/27

(52) U.S. Cl. CPC H04W 36/0088; H04W 76/27

(57) ABSTRACT

A method and a device for neighbouring cell measurement, and the method for neighbouring cell measurement includes the following. A terminal device receives a first message from a serving cell. The first message is used to configure a relaxed measurement criterion. A measurement is performed on a first frequency corresponding to a first cell based on the first message. The first cell is a neighbouring cell supporting a target service.

### CROSS-REFERENCE TO RELATED DISCLOSURE (S)

The application is a National Stage of International Application No. PCT/CN2021/119357, field Sep. 18, 2021, which claims priority to Chinese Patent Application No. 202110878081.5, field Jul. 30, 2021, the entire disclosure of which are incorporated herein by reference.

### TECHNICAL FIELD

The present disclosure relates to the field of communication technology, in particular to a method and an apparatus for neighbouring cell measurement.

### BACKGROUND

For a user equipment (UE) in a radio resource control (RRC) idle state (RRC_IDLE) and an RRC inactive state (RRC_INACTIVE), in order to fulfil a mobility requirement, the UE needs to perform a neighbouring cell measurement, to measure neighbouring cells on different frequencies or employing different radio access technologies (RATs).

In order to reduce power consumption, 3rd generation partnership project (3GPP) optimizes a not-at-cell-edge UE and a UE with low mobility, i.e., relaxes a measurement for a neighbouring cell performed by the UE. When a terminal device fulfils a relaxed measurement criterion, the UE may relax a measurement for an intra-frequency neighbouring cell, an inter-frequency neighbouring cell, or an inter-system neighbouring cell. However, in case where the UE performs a relaxed measurement or does not perform the measurement for the intra-frequency neighbouring cell or the inter-frequency neighbouring cell, it is disadvantageous for the UE that needs to provide a certain type of service and needs to camp on a cell supporting the service as soon as possible.

### SUMMARY

In a first aspect, the embodiments of the present disclosure provide a method for neighbouring cell measurement and the method includes the following. A terminal device receives a first message from a serving cell. The first message is used to configure a relaxed measurement criterion. The terminal device performs a measurement for a first frequency corresponding to a first cell based on the first message. The first cell is a neighbouring cell supporting a target service.

In a second aspect, the embodiments of the present disclosure provide a terminal device. The terminal device includes a processor, a memory, a communication interface, and one or more programs. The one or more programs are stored in the memory and configured to be executed by the processor. The programs include instructions configured to perform some or all of operations of the method described in the above first aspect.

In a third aspect, the embodiments of the present disclosure provide a non-transitory computer-readable storage medium. The computer-readable storage medium is configured to store computer programs for electronic-data interchange (EDI). The computer programs are configured to cause a computer to perform some or all of operations of the method described in the above first aspect.

### BRIEF DESCRIPTION OF THE DRAWINGS

To describe technical solutions of embodiments more clearly, the following will give a brief introduction to accompanying drawings used for describing the embodiments. Apparently, the accompanying drawings hereinafter described are some embodiments of the disclosure. Based on these drawings, those of ordinary skill in the art can also obtain other drawings without creative effort.

FIG. 1 is a schematic diagram of a communication system provided in the embodiments of the present disclosure.

FIG. 2 is a schematic flowchart of a method for neighbouring cell measurement provided in an embodiment of the present disclosure.

FIG. 3 is a schematic flowchart of a method for neighbouring cell measurement provided in another embodiment of the present disclosure.

FIG. 4 is a schematic flowchart of a method for neighbouring cell measurement provided in another embodiment of the present disclosure.

FIG. 5 is a schematic flowchart of a method for neighbouring cell measurement provided in another embodiment of the present disclosure.

FIG. 6 is a schematic flowchart of a method for neighbouring cell measurement provided in another embodiment of the present disclosure.

FIG. 7 is a schematic flowchart of a method for neighbouring cell measurement provided in another embodiment of the present disclosure.

FIG. 8 is a schematic flowchart of a method for neighbouring cell measurement provided in another embodiment of the present disclosure.

FIG. 9 is a block diagram illustrating functional units of an apparatus for neighbouring cell measurement provided in an embodiment of the present disclosure.

FIG. 10 is a schematic structural diagram of a terminal device provided in an embodiment of the present disclosure.

### DETAILED DESCRIPTION

The following will describe embodiments of the present disclosure with reference to the accompanying drawings in the embodiments of the present disclosure.

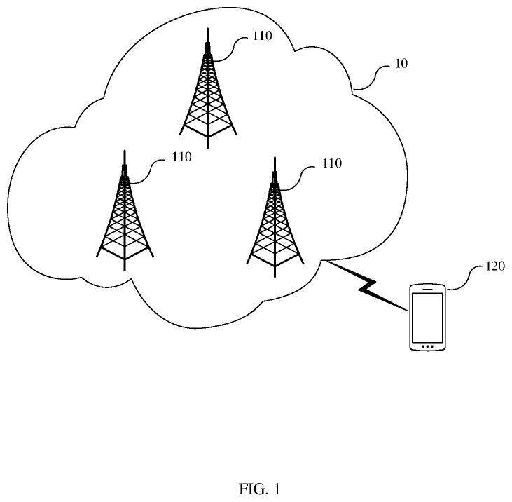

Reference is made to FIG. 1, where FIG. 1 is a schematic diagram of a communication system provided in the embodiments of the present disclosure. As illustrated in FIG. 1, the communication system includes multiple network devices 110 and a terminal device 120. The multiple network devices 110 may be deployed in a radio access network (RAN) 10. The terminal device 120 is generally implemented as multiple terminal devices. One or more terminal devices 120 may be disposed in a cell managed by each network device 110. In the embodiments of the present disclosure, in case the terminal device 120 enters a coverage area of the system, the terminal device 120 performs a cell search process. The terminal device 120 searches for a cell fulfilling a requirement within the coverage area of one or more network devices 110.

The network device 110 and the terminal device 120 may communicate with each other via radio technology, e.g., via cellular technology. The solutions described in the embodiments of the present disclosure may be applicable to a system of the 5th generation mobile communication technology (5G) mobile communication technology, an evolved long term evolution (eLTE) system, a communication system integrating multiple communication technologies (e.g., a communication system integrating LTE technology and NR technology), or a subsequent evolved communication system.

The terminal device 120 is in the coverage range of the network device 110. In a practical application, a connection between the foregoing devices may be a wireless connection. In order to conveniently illustrate a connection relationship between the various devices, FIG. 1 uses solid lines for illustration. A communication link between the network device 110 and the terminal device 120 may include a down link (DL) transmission from the network device 110 to the terminal device 120, and/or an up link (UP) transmission from the terminal device 120 to the network device 110. The DL transmission may also be referred to as a forward link transmission and the UP transmission may also be referred to as a reverse link transmission.

The terminal device related in the embodiments of the present disclosure includes a device with wireless communication function. The terminal device may be a mobile phone, a pad, a computer with wireless transceiving functions, a terminal device for virtual reality (VR), a terminal device for augmented reality (AR), a wireless terminal in industrial control, a wireless terminal in self driving, a wireless terminal in remote medical, a wireless terminal in smart grid, and a wireless terminal device in smart home, etc. The terminal device may also be a handheld device with wireless communication function, an in-vehicle device, a wearable device, a network device, or other processing devices coupled with a wireless modem, a terminal device in the future 5G network or a terminal device in the future evolved public land mobile network (PLMN), etc. The terminal device can have different names in different networks, such as a user device, an access terminal, a subscriber unit, a subscriber station, a mobile platform, a mobile station (MS), a remote station, a remote terminal, a mobile device, a user terminal, a terminal, a wireless communication device, a user agent or a user apparatus, a cellular radio telephone, a cordless telephone, a session initiation protocol (SIP) telephone, a wireless local loop (WLL) station, a personal digital assistant (PDA), or a terminal device in the 5G network or a future evolved network, which is not limited in the embodiments of the present disclosure.

The network device 110 in the RAN related in the embodiments of the present disclosure may be a base station (BS). The BS is an apparatus deployed in the RAN to provide wireless communication function for the terminal. The BS may include various forms of a macro BS, a micro BS, a relay station, and an access point, etc. In systems employing different radio access technologies (RATs), devices with the function of BS may have different names, for example, the device may be called an evolved NodeB (eNB or eNodeB) in the LTE system, or called a Node B (NB) in the 3G communication system, or called a next-generation Node B (gNB) or a next generation evolved NodeB (ng-eNB) in the new radio (NR) system. gNB and the terminal device communicate using NR technology. ng-eNb and the terminal device communicate using evolved universal terrestrial radio access (E-UTRA) technology. gNb and ng-eNB both can connect to the 5G core network. The network device in the embodiments of the present disclosure further includes a device that provides the BS function in new future communication system. With the evolution of communication technologies, the name of “base station” may change. For case of description, in the embodiments of the present disclosure, the foregoing apparatus for providing the wireless communication function for the terminal device 120 is generally referred to as the network device.

It is noted that, the form and the number of the network device 110 and the terminal device 120 illustrated in FIG. 1 are only used for examples and do not constitute a limitation to embodiments of the present disclosure.

For a terminal device in an idle state or an inactive state, in order to fulfil a mobility requirement, the terminal device needs to perform a neighbouring cell measurement so as to measure neighbouring cells on different frequencies or employing different radio access technologies (RATs), which includes an intra-frequency cell, an inter-frequency cell, and an inter-system cell. System information of a serving cell where the terminal device camps usually broadcasts a neighbouring cell configuration on multiple frequencies. Different frequencies have different frequency priorities. The terminal device needs to measure the neighbouring cell of a frequency with a higher priority than the frequency on which the terminal device camps. Once a reselection condition is fulfilled, i.e. a cell on a high-priority frequency exceeds a threshold Thresh_{X, HighQ} or a threshold Thresh_{X, HighP}, the terminal device needs to reselect the cell on the high-priority frequency. For (inter-frequency) frequencies with the same priority as the currently camped frequency, when a signal quality of the serving cell is lower than a certain threshold, the terminal device needs to measure the neighbouring cells on these frequencies with the same frequency priority. Then the neighbouring cells are ranked based on the measured signal quality, and the terminal device needs to reselect a highest ranked cell. For frequencies with a priority lower than that of the currently camped frequency, only when the signal quality of the serving cell is poor (e.g., lower than a set threshold SnonIntraSearchP), the terminal device measures the neighbouring cells on these frequencies with lower priority. When the signal quality of the serving cell is lower than a threshold, such as Thresh_{Serving, LowQ}, and the signal quality of the neighbouring cells on the low-priority frequencies being higher than a threshold such as Thresh_{X, LowQ}, the terminal device may reselect a cell on the low-priority frequency.

If the measurement is relatively frequent, it is relatively power-consuming for the terminal device, therefore, a relaxed measurement mechanism is introduced in a 5G communication protocol. A relaxed measurement reduces the number of frequencies needed to be measured by the terminal device, reduces the measurement time, and extend a measurement period of the periodic measurement. For the terminal device in a 5G communication system, if the terminal device is determined to be moving at a low speed or not at a cell edge, the relaxed measurement may be triggered. The terminal device needs to determine whether the terminal device can relax radio resource management (RRM) measurement, and a specific standard is set by a system information block 2 (SIB2).

The SIB2 optionally provides a configuration for the relaxed measurement, including a low mobility criterion, a not-at-cell-edge criterion, a relaxed measurement criterion, and whether a measurement for a high-priority frequency can be relaxed. When the terminal device determines that the terminal device fulfils the relaxed measurement criterion, the terminal device may relax the measurement for an intra-frequency, an inter-frequency with the same frequency priority, an inter-frequency with a lower frequency priority, or an inter-system neighbouring cell with the lower frequency priority. When the SIB2 indicates that the measurement for the high-priority frequency (highPriorityMeasRelax) can be relaxed, the terminal device may relax the measurement for an inter-frequency neighbouring cell with a high frequency priority and an inter-system neighbouring cell with the high frequency priority, after the relaxed measurement criterion is determined to be fulfilled. If the highPriorityMeasRelax is not configured but the terminal device is moving at a low speed and is not at a cell edge, the terminal device may perform the relaxed measurement for the inter-frequency (including the high-priority frequency) and the inter-system. The relaxed measurement criterion is based on the signal quality of the cell and not based on the signal quality of a beam.

The low mobility criterion is judged based on a delta value of a reference signal received power (RSRP) of the serving cell, which is specifically as follows. (Srxlev_{Ref}−Srxlev)<S_{SearchDeltap}. Srxlev is a current Srxlev value of the serving cell. Srxlev_{Ref} is a reference Srxlev value of the serving cell, and is set as follows. After selecting or reselecting a new cell, or if (Srxlev−Srxlev_{Ref})>0, or if the relaxed measurement criterion has not been met for T_{SearchDeltaP}, the terminal device shall set the value of Srxlev_{Ref} to the current Srxlev value of the serving cell.

The not-at-cell-edge criterion is judged based on the signal quality RSRP and/or a reference signal received quality (RSRQ) of the cell, which is specifically as follows. Srxlev>S_{SearchThresholdP}. And Squal>S_{SearchThresholdQ}, if S_{SearchThresholdQ} is configured. Srxlev and Squal are current measurement values of the serving cell.

1) If the low mobility criterion (lowMobilityEvaluation) is configured in the SIB2 and the not-at-cell-edge criterion is not configured in the SIB2, and if the terminal device has performed intra-frequency, NR inter-frequency, or inter-system frequency measurements for at least T_{SearchDeltaP} after (re-)selecting a new cell, and if the low mobility criterion is fulfilled for a period of T_{SearchDeltaP}, the terminal device may choose to perform the relaxed measurement for the intra-frequency. If the serving cell fulfils Srxlev>S_{IntraSearchP} and Squal>S_{IntraSearchQ}, for any NR inter-frequency or inter-system frequency with the high priority, if less than 1 hour has passed since measurements of corresponding frequencies for cell reselection were last performed, and if highPriorityMeasRelax is configured with value true, the terminal device may not perform measurement on these frequencies. If the serving cell fulfils Srxlev≤S_{nonIntraSearchp} or Squal≤S_{nonIntraSearchQ}, the terminal device may perform the relaxed measurement for the NR inter-frequency or the inter-system frequency.

2) If the not-at-cell-edge criterion (cellEdgeEvaluation) is configured in the SIB2 and the low mobility criterion is not configured in the SIB2, and if the terminal device fulfils the not-at-cell-edge criterion, the terminal device may perform the relaxed measurement for the intra-frequency. If the serving cell fulfils Srxlev≤S_{nonIntraSearchP} or Squal≤S_{nonIntraSearchQ}, the terminal device may perform the relaxed measurement for the NR inter-frequency or the inter-system frequency.

3) If the not-at-cell-edge criterion and the low mobility criterion are configured in the SIB2, and if the terminal device has performed normal intra-frequency, NR inter-frequency, or inter-system frequency measurements for at least T_{SearchDeltaP} after reselecting a cell, the low mobility criterion is fulfilled for a period of T_{SearchDeltaP}, and the terminal device fulfils the not-at-cell-edge criterion, for the intra-frequency, any NR inter-frequency, or any inter-system frequency, if less than 1 hour has passed since measurements of corresponding frequency cell(s) for cell reselection were last performed, the terminal device may not perform the measurement for this frequency cell(s). Otherwise, if the terminal device has performed normal intra-frequency, NR inter-frequency, or inter-RAT frequency measurements for at least T_{SearchDeltaP} after reselecting a cell, and the low mobility criterion is fulfilled for a period of T_{SearchDeltaP}, or if the terminal device fulfils the not-at-cell-edge criterion, and combineRelaxedMeasCondition is not configured, the terminal device may perform the relaxed measurement for intra-frequencies, NR inter-frequencies of equal or lower priority, or inter-system frequencies of equal or lower priority. If the serving cell fulfils Srxlev≤S_{nonIntraSearchP} or Squal≤S_{nonIntraSearchQ}, the terminal device may perform the relaxed measurement for NR inter-frequencies with the higher priority or inter-system frequencies with the higher priority.

In the related technology, when the terminal device fulfils the relaxed measurement criterion, the terminal device may perform the relaxed measurement or not perform the measurement on the intra-frequency neighbouring cell, the inter-frequency neighbouring cell, or the inter-system neighbouring cell. However, in case a neighbouring cell supporting the user desired service exits in the intra-frequency, inter-frequency, or inter-system, if the relaxed measurement mechanism is applied, the terminal device is unable to quickly detect the cell supporting the user desired service, so that a delay of establishing a needed corresponding service (such as some slice services) by the terminal device in the future is affected, thereby affecting a user experience.

In order to solve the problem described above, the present disclosure provides a method for neighbouring cell measurement. With the method, the neighbouring cell supporting the target service can be preferentially measured by determining a measurement approach for the neighbouring cell supporting the target service based on a configured relaxed measurement criterion, so that the terminal device can preferentially reselect a cell supporting the target service, and a service requirement of the terminal device can be fulfilled.

In order to enable those skilled in the art to better understand the solutions of the present disclosure, technical solutions of the embodiments of the present disclosure will be described clearly and completely with reference to accompanying drawings in the embodiments of the present disclosure. Apparently, the embodiments described herein are merely some embodiments, rather than all embodiments, of the disclosure. Based on the embodiments described herein, all other embodiments obtained by those of ordinary skill in the art without creative effort shall fall within the protection scope of the disclosure.

Reference is made to FIG. 2, where FIG. 2 is a schematic flowchart of a method for neighbouring cell measurement provided in an embodiment of the present disclosure, and the method is applied to the communication system illustrated in FIG. 1. As illustrated in FIG. 2, the method includes the following operations.

At block S210, a terminal device receives a first message from a serving cell, where the first message is used to configure a relaxed measurement criterion.

The relaxed measurement criterion includes at least one of: a low mobility criterion, a not-at-cell-edge criterion, or a stationary criterion.

Specifically, the first message may be a SIB2 message. The serving cell where the terminal device camps may provide, via the SIB2 message, a configuration for relaxed measurement including the low mobility criterion, the not-at-cell-edge criterion, the stationary criterion, the relaxed measurement criterion, and whether a measurement for a high-priority frequency can be relaxed, when the terminal device determines that the terminal device fulfils the relaxed measurement criterion, the terminal device may determine an approach for measuring an intra-frequency neighbouring cell, an inter-frequency neighbouring cell, or an inter-system neighbouring cell.

At block S220, the terminal device performs the measurement for a first frequency corresponding to a first cell based on the first message, where the first cell is a neighbouring cell supporting a target service.

When the terminal device fulfils the relaxed measurement criterion, and the neighbouring cell for which the relaxed measurement is performed is able to provide the target service which the terminal device wants to access, in order to enable a terminal device to access a cell supporting the target service as soon as possible, in the embodiment of the present disclosure, when the terminal device fulfils the relaxed measurement criterion, an approach for measuring the neighbouring cell supporting the target service is re-determined to enable the neighbouring cell supporting the target service to be measured preferentially, so that the terminal device can preferentially reselect the cell supporting the target service, and a service requirement of the terminal device can be fulfilled.

The target service includes any one of: one or more slice services, a multicast service, or a service established in a closed-mode cell.

In the embodiment of the present disclosure, the target service may be an intended slice, and each slice corresponds to a service type. The target service may be a service that the terminal device expects to establish in the future, such as a high-definition voice service, a high-definition video service, a low-delay service, and a low-delay high-reliability service, etc. The target service may also be the multicast service expected to be accessed by the terminal device, or the service developed in the closed-mode cell expected to be accessed by the terminal device.

Exemplarily, the first cell may further be a cell supporting the multicast service and expected to be accessed by the terminal device, or a closed-mode cell being a member and expected to be accessed by the terminal device. In case where the terminal device needs to preferentially access these cells, if the terminal device currently fulfils the relaxed measurement criterion, for the cell supporting the multicast service or the closed-mode cell being the member, the terminal device may perform the measurement with the method described above, so as to camp on these cells as soon as possible.

It is noted that the first cell may further be a cell expected to be accessed by the terminal device in other application scenarios, or a cell that supports other desired services, which is not limited in the embodiment of the present disclosure.

In a possible example, the terminal device performs the measurement for the first cell based on the first message as follows.

When the terminal device fulfils the low mobility criterion and/or the not-at-cell-edge criterion and the serving cell does not support the target service, the terminal device performs the measurement for the first cell of at least one of an intra-frequency, an inter-frequency, or an inter-system or performs the measurement for the first cell of at least one of the intra-frequency, the inter-frequency, or the inter-system after adjusting a measurement parameter, (i.e., the relaxed measurement is not performed). When the terminal device fulfils the low mobility criterion and/or the not-at-cell-edge criterion and the serving cell supports the target service, the terminal device performs the relaxed measurement for the first cell of the intra-frequency.

The terminal device is in a radio resource control (RRC) inactive state or an RRC idle state.

In the embodiment of the present disclosure, the terminal device in the idle state or the inactive state needs to perform the measurement for the serving cell and the neighbouring cell based on a measurement requirement in a cell reselection process. When the terminal device fulfils the relaxed measurement criterion for neighbouring cells on a same frequency as the current serving cell (i.e., intra-frequency), if the serving cell on which the terminal device camps does not supports the target service but the intra-frequency neighbouring supports the target service, the terminal device may perform a normal measurement for the intra-frequency neighbouring cell supporting the target service in order to camp on the cell supporting the target service. If the serving cell on which the terminal device currently camps supports the target service, the terminal device may perform the relaxed measurement for the intra-frequency neighbouring cell or not perform the measurement for the intra-frequency neighbouring cell for a period of time, so as to reduce power consumption.

In the embodiment of the present disclosure, the terminal device in the idle state or the inactive state needs to perform the measurement for the serving cell and the neighbouring cell based on the measurement requirement in the cell reselection process. When the terminal device fulfils the relaxed measurement criterion for neighbouring cells using a frequency different from that of the current serving cell (i.e., inter-frequency) or employing a RAT access different from the terminal device (i.e., inter-system), considering that the terminal device needs to preferentially camp on the cell supporting the target service, if the serving cell on which the terminal device currently camps does not supports the target service but the inter-frequency neighbouring cells and the inter-system neighbouring cells support the target service, the terminal device may perform the normal measurement for the inter-frequency neighbouring cell and the inter-system neighbouring cell supporting the target service in order to camp on the cell supporting the target service.

Exemplarily, in order to further fulfil a user's requirement, a new measurement requirement (the measurement requirement specified in a protocol) may be introduced, and the terminal device is required to perform the measurement for the neighbouring cell of at least one of the intra-frequency, the inter-frequency, or the inter-system based on the new measurement requirement, i.e., to perform the measurement for the neighbouring cell of at least one of the intra-frequency, the inter-frequency, or the inter-system after adjusting the measurement parameter. For example, the terminal device may be required to perform more frequently the measurement for a cell on a frequency of at least one of the intra-frequency, the inter-frequency, or the inter-system in order to find out the cell supporting the target service as soon as possible, so that when the cell of at least one of the intra-frequency, the inter-frequency, or the inter-system fulfils a threshold of signal quality, the terminal device may camp on the cell at once, so as to subsequently transmit the target service.

Further, if the serving cell on which the terminal device currently camps supports the target service, the terminal device may perform the relaxed measurement for the inter-frequency neighbouring cell and/or the inter-system neighbouring cell or not perform the measurement for the inter-frequency neighbouring cell and/or the inter-system neighbouring cell for the period of time, so as to reduce power consumption.

Optionally, when a priority of the target service supported by the serving cell is lower than a priority of the target service supported by the first cell, the terminal device performs any one of the measurement, the measurement after adjusting the measurement parameter, or ignoring the relaxed measurement criterion for the first cell of at least one of the intra-frequency, the inter-frequency, or the inter-system.

The terminal device may expect to establish multiple slices, and the multiple slices may correspond to one or more target services, therefore, the terminal device may have multiple target services. The target services corresponding to the different slices may have the same priority, or have different priorities. Therefore, if the serving cell where the terminal device currently camps supports the target service, the inter-frequency neighbouring cell and/or the inter-system neighbouring cell also supports the target service, and the priority of the target service supported by the inter-frequency neighbouring cell and/or the inter-system neighbouring cell is higher than the priority of the target service supported by the serving cell where the terminal device currently camps, the terminal device may perform the normal measurement for the inter-frequency neighbouring cell and/or the inter-system neighbouring cell, in order to find out the cell supporting the target service with a higher priority as soon as possible, so as to subsequently transmit the target service.

Exemplarily, the new measurement requirement (the measurement requirement specified in the protocol) may be introduced for the terminal device to require the terminal device to perform the measurement for the inter-frequency neighbouring cell and/or the inter-system neighbouring cell supporting the target service with the higher priority based on the new measurement requirement. For example, the terminal device may be required to perform more frequently the measurement for the cell on the frequency of the inter-frequency and/or the inter-system in order to find out the cell supporting the target service as soon as possible, so that when an inter-frequency cell and/or an inter-system neighbouring cell fulfils the threshold of signal quality, the terminal device may camp on the cell at once, so as to subsequently transmit the target service.

In a possible example, the terminal device performs the measurement for the first cell based on the first message as follows.

When the serving cell does not support the target service, the terminal device performs any one of the measurement, the measurement after adjusting the measurement parameter, or the relaxed measurement for the first cell of at least one of the intra-frequency, the inter-frequency, or the inter-system.

The terminal device is in the idle state, the inactive state, or a stationary state.

In the embodiment of the present disclosure, for the terminal device in the idle state or the inactive state, when the terminal device receives the relaxed measurement criterion, the terminal device may ignore the relaxed measurement criterion. Alternatively, after the terminal device receives the relaxed measurement criterion, the terminal device may directly perform the normal measurement for the neighbouring cell of at least one of the intra-frequency, the inter-frequency, or the inter-system supporting the target service when the serving cell where the terminal device currently camps does not support the target service but the neighbouring cell of at least one of the intra-frequency, the inter-frequency, or the inter-system supports the target service. That is, the terminal device does not determine whether the terminal device fulfils the low mobility criterion and/or the not-at-cell-edge criterion after receiving the relaxed measurement criterion and directly performs the normal measurement for the neighbouring cell of at least one of the intra-frequency, the inter-frequency, or the inter-system supporting the target service when the serving cell where the terminal device currently camps does not support the target service.

Exemplarily, in order to further fulfil the user's requirement, the new measurement requirement (the measurement requirement specified in the protocol) may be introduced, and the terminal device is required to perform the measurement for the neighbouring cell of at least one of the intra-frequency, the inter-frequency, or the inter-system supporting the target service based on the new measurement requirement, i.e., the terminal device performs the measurement for the neighbouring cell of at least one of the intra-frequency, the inter-frequency, or the inter-system supporting the target service after adjusting the measurement parameter. For example, the terminal device may be required to perform more frequently the measurement for the cell on the frequency of at least one of the intra-frequency, the inter-frequency, or the inter-system in order to find out the cell supporting the target service as soon as possible, so that when the cell of at least one of the intra-frequency, the inter-frequency, or the inter-system fulfils the threshold of signal quality, the terminal device may camp on the cell at once, so as to subsequently transmit the target service.

For a terminal device in the stationary state, when the terminal device receives the relaxed measurement criterion, the terminal device may ignore the relaxed measurement criterion. Alternatively, after the terminal device receives the relaxed measurement criterion, the terminal device may directly perform the normal measurement or the relaxed measurement for the neighbouring cell of at least one of the intra-frequency, the inter-frequency, or the inter-system supporting the target service when the serving cell where the terminal device currently camps does not support the target service but the neighbouring cell of at least one of the intra-frequency, the inter-frequency, or the inter-system supports the target service. That is, the terminal device does not determine whether the terminal device fulfils the stationary criterion after receiving the stationary criterion, and directly performs the normal measurement or the relaxed measurement for the neighbouring cell of at least one of the intra-frequency, the inter-frequency, or the inter-system supporting the target service when the serving cell where the terminal device currently camps does not support the target service.

In a possible example, the terminal device performs the measurement for the first cell based on the first message as follows.

When the terminal device fulfils the stationary criterion and the serving cell does not support the target service, the terminal device performs the measurement or the relaxed measurement for the first cell of the intra-frequency. When the terminal device fulfils the stationary criterion and the serving cell of the terminal device supports the target service, the terminal device performs the measurement only for the serving cell (i.e. the measurement for the intra-frequency neighbouring cell may not be performed).

The terminal device is in the stationary state. The stationary state is a state newly introduced in the protocol, for example, whether the terminal device is in the stationary state can be determined based on the changes of a precise location of the terminal device, such as a variation of the RSRP of the serving cell being lower than a pre-set threshold. It is noted that other more precise criteria may be introduced in the protocol, and the present disclosure does not construct a limitation on a specific criterion of the stationary state.

In the embodiment of the present disclosure, the terminal device in the stationary state also re-determines the approach for performing the measurement for the intra-frequency neighbouring cell, the inter-frequency neighbouring cell, or the inter-system frequency cell based on the relaxed criterion. In case where the terminal device does not need to perform the measurement for the intra-frequency neighbouring cell (i.e., the terminal device fulfils the stationary state and does not need to perform the measurement for the intra-frequency neighbouring cell), if the serving cell where the terminal device currently camps does not support the target service but the intra-frequency neighbouring cell supports the target service, the terminal device may perform the measurement or the relaxed measurement for the intra-frequency neighbouring cell supporting the target service in order to camp on the cell supporting the target service.

Further, if the serving cell where the terminal device currently camps supports the target service, the terminal device may not perform the measurement for the intra-frequency neighbouring cell, so as to reduce power consumption.

In a possible example, the terminal device performs the measurement for the first cell based on the first message as follows. When the terminal device fulfils the stationary criterion and the serving cell of the terminal device does not support the target service, the terminal device performs the measurement or the relaxed measurement for the first cell of the inter-frequency and/or the inter-system. When the terminal device fulfils the stationary criterion and the serving cell of the terminal device supports the target service, the terminal device performs the measurement for the first cell of the inter-frequency and/or the inter-system after a first period.

The terminal device is in the stationary state. The terminal device in the stationary state needs to perform the measurement for the serving cell and the neighbouring cell based on the measurement requirement in the cell reselection process. In case where the terminal device does not need to perform the measurement for the inter-frequency neighbouring cell and/or the inter-system neighbouring cell, if the serving cell where the terminal device currently camps does not support the target service but the inter-frequency neighbouring cell and/or the inter-system neighbouring cell supports the target service, the terminal device may perform the measurement or the relaxed measurement for the inter-frequency neighbouring cell and/or the inter-system neighbouring cell supporting the target service, in order to camp on the cell supporting the target service. If the serving cell where the terminal device currently camps supports the target service, the terminal device may not perform the measurement for the inter-frequency neighbouring cell and/or the inter-system neighbouring cell for the period of time and perform the measurement for the inter-frequency neighbouring cell and/or the inter-system neighbouring cell after the period of time, so as to reduce power consumption. In other words, for the terminal device in the stationary state, if the serving cell where the terminal device currently camps supports the target service, the terminal device needs to perform at least one measurement for the inter-frequency neighbouring cell and/or the inter-system neighbouring cell every period of time (e.g. 1 hour) and the terminal device may not perform the measurement for the frequency within 1 hour after the measurement was last performed.

It is noted that the present disclosure may determine whether the terminal device fulfils the low mobility criterion and/or the not-at-cell-edge criterion by employing the related art. The specific criterion is not repeated here.

Optionally, the method further includes the following. The terminal device receives a third message from the serving cell. The third message indicates at least one of frequency information, location area information, or a cell identifier for supporting the target service. The terminal device determine the first cell based on the third message.

In the embodiment of the present disclosure, the serving cell may send the third message to the terminal device before sending the first message to the terminal device. The third message may be system information or a dedicated signalling. The dedicate signalling may be an RRC release message. The serving cell may indicate the frequency information for supporting the target service, the location area information for supporting the target service, or the cell identifier for the cell supporting the target service in the system information or the dedicated signalling. The terminal device may learn whether a cell supporting the target service is in the intra-frequency neighbouring cell, the inter-frequency neighbouring cell, or the inter-system neighbouring cell of the serving cell where the terminal device camps upon receiving the third message. When the terminal device in the idle state or the inactive state does not camp on the cell supporting the target service, the terminal device needs to perform the normal measurement for the intra-frequency neighbouring cell, the inter-frequency neighbouring cell, or the inter-system neighbouring cell that may support the target service. When the terminal device in the stationary state does not camp on the cell supporting the target service, the terminal device needs to perform the relaxed measurement or not perform the measurement for the period of time for the intra-frequency neighbouring cell, the inter-frequency neighbouring cell, or the inter-system neighbouring cell that may support the target service.

Optionally, the method further includes the following. The terminal device receives a second message from the serving cell. The second message indicates whether the terminal device applies the relaxed measurement. When the second message indicates that the terminal device does not apply the relaxed measurement, the terminal device performs the measurement for the neighbouring cell supporting the target service or performs the measurement for the neighbouring cell supporting the target service after adjusting the measurement parameter.

The serving cell may further set whether the terminal device applies a relaxed measurement mechanism on the intra-frequency neighbouring cell, the inter-frequency neighbouring cell, or the inter-system neighbouring cell supporting the target service specifically as follows. The serving cell sends the second message to the terminal device. The second message indicates whether the terminal device can apply the relaxed measurement mechanism. When the serving sell indicates that the terminal device can apply the relaxed measurement mechanism, the terminal device performs the measurement with the method described above. When the serving sell indicates that the terminal device does not apply the relaxed measurement mechanism, the terminal device always performs the normal measurement for the intra-frequency neighbouring cell, the inter-frequency neighbouring cell, or the inter-system neighbouring cell supporting the target service, or the terminal device performs the measurement for the intra-frequency neighbouring cell, the inter-frequency neighbouring cell, or the inter-system neighbouring cell supporting the target service based on an introduced new measurement requirement. However, the measurement for the neighbouring cell is not influenced by the configuration when the serving cell does not support the target service. The second message may be the system information or the dedicated signalling. The dedicated signalling may be the RRC release message.

In the embodiment of the present disclosure, the terminal device receives the first message from the serving cell. The first message is used to configure the relaxed measurement criterion. The terminal device performs the measurement for the first frequency corresponding to the first cell based on the first message. The first cell is the neighbouring cell supporting the target service. In the present disclosure, the neighbouring cell supporting the target service can be preferentially measured by determining the approach for measuring the neighbouring cell supporting the target service based on the configured relaxed measurement criterion, so that the terminal device can preferentially reselect the cell supporting the target service, and the service requirement of the terminal device can be fulfilled.

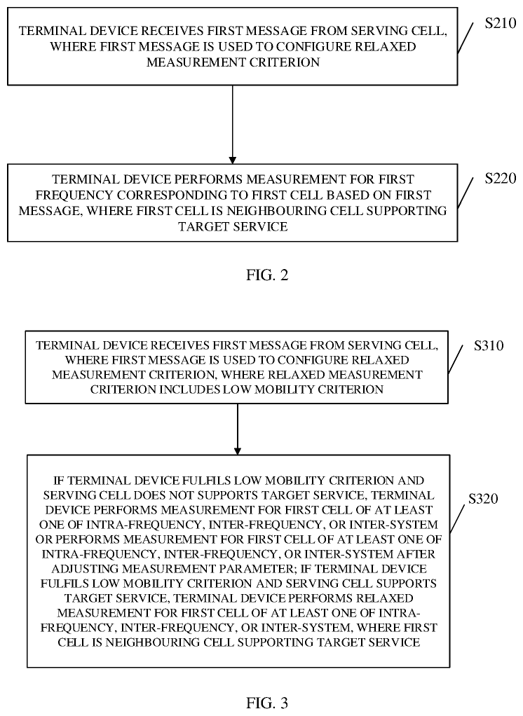

The implementation of the present disclosure is described in detail below with respect to a case that different measurement criteria are included in a relaxed measurement criterion and with respect to whether a serving cell supports a target service respectively. Reference is made to FIG. 3, where FIG. 3 is a schematic flowchart of a method for neighbouring cell measurement provided in another embodiment of the present disclosure, and the method is applied to a communication system illustrated in FIG. 1. As illustrated in FIG. 3, the method includes the following operations.

### Embodiment 1

At block S310, a terminal device receives a first message from a serving cell, where the first message is used to configure a relaxed measurement criterion, and the relaxed measurement criterion includes a low mobility criterion.

The first message may be an SIB2 message. The terminal device is in an RRC inactive state or an RRC idle state. The serving cell where the terminal device camps may configure the low mobility criterion via the SIB2 message. Upon determining that the terminal device fulfils the relaxed measurement criterion, the terminal device may determine an approach for measuring an intra-frequency neighbouring cell.

At block S320, when the terminal device fulfils the low mobility criterion and the serving cell does not support the target service, the terminal device performs a measurement for a first cell of at least one of an intra-frequency, an inter-frequency, or an inter-system or performs the measurement for the first cell of at least one of the intra-frequency, the inter-frequency, or the inter-system after adjusting a measurement parameter. When the terminal device fulfils the low mobility criterion and the serving cell supports the target service, the terminal device performs a relaxed measurement for the first cell of at least one of the intra-frequency, the inter-frequency, or the inter-system. The first cell is a neighbouring cell supporting the target service.

In the embodiment of the present disclosure, the target service may be an intended slice, and each slice corresponds to a service type. The target service may be a service that the terminal device expects to establish in the future, which may include a high-definition voice service, a high-definition video service, a low-delay service, and a low-delay high-reliability service, etc.

Exemplarily, the first cell may further be a cell supporting a multicast service and expected to be accessed by the terminal device, or a closed-mode cell being a member and expected to be accessed by the terminal device. In case where the terminal device needs to preferentially access these cells, if the terminal device currently fulfils the relaxed measurement criterion, for the cell supporting the multicast service or the closed-mode cell being the member, the terminal device may perform the measurement with the method described above, so as to camp on these cells as soon as possible.

It is noted that the first cell may further be a cell expected to be accessed by the terminal device in other application scenarios, or a cell that supports other desired services, which is not limited in the embodiment of the present disclosure.

The low mobility criterion (lowMobilityEvaluation) is configured in the SIB2 sent by the serving cell, and a not-at-cell-edge criterion is not configured in the SIB2 sent by the serving cell. For the terminal device in the idle state or in the inactive state, when the terminal device has performed the measurement for the intra-frequency for at least T_{SearchDeltaP} after (re-)selecting a new cell, and the serving cell fulfils (Srxlev_{Ref}−Srxlev)<S_{SearchDeltaP} (i.e. the terminal device fulfils the low mobility criterion), if the serving cell where the terminal device currently camps does not supports the target service but the intra-frequency neighbouring cell supports the target service, the terminal device may perform a normal measurement for the intra-frequency neighbouring cell supporting the target service or perform the measurement for the intra-frequency neighbouring cell supporting the target service after adjusting the measurement parameter (i.e. the relaxed measurement is not performed) in order to camp on the cell supporting the target service. If the serving cell where the terminal device currently camps supports the target service, the terminal device may perform the relaxed measurement for the intra-frequency neighbouring cell or not perform the measurement for the intra-frequency neighbouring cell for a period of time, so as to reduce power consumption.

The low mobility criterion (lowMobilityEvaluation) is configured in the SIB2 sent by the serving cell, and the not-at-cell-edge criterion is not configured in the SIB2 sent by the serving cell. For the terminal device in the idle state or in the inactive state, when the serving cell fulfils Srxlev>S_{SearchThresholdP} and Squal>S_{SearchThresholdQ} and highPriorityMeasRelax is configured with value true, or the serving cell fulfils Srxlev≤S_{nonIntraSearchP} or Squal≤S_{nonIntraSearchQ}, if the serving cell where the terminal device camps does not support the target service but an inter-frequency neighbouring cell and/or an inter-system neighbouring cell supports the target service, the terminal device may perform the normal measurement for the inter-frequency neighbouring cell and/or the inter-system neighbouring cell supporting the target service (i.e. the relaxed measurement is not performed) in order to camp on the cell supporting the target service. If the serving cell where the terminal device currently camps supports the target service, the terminal device may perform the relaxed measurement for the inter-frequency neighbouring cell and/or the inter-system neighbouring cell or not perform the measurement for the inter-frequency neighbouring cell and/or the inter-system neighbouring cell for the period of time, so as to reduce power consumption.

Further, when the serving cell where the terminal device currently camps supports the target service, the inter-frequency neighbouring cell and/or the inter-system neighbouring cell also supports the target service, and a priority of the target service supported by the inter-frequency neighbouring cell and/or the inter-system neighbouring cell is higher than a priority of the target service supported by the serving cell where the terminal device currently camps, the terminal device may perform the normal measurement for the inter-frequency neighbouring cell and/or the inter-system neighbouring cell in order to find out the cell supporting the target service with a higher priority as soon as possible, so as to subsequently transmit the target service.

Exemplarily, a new measurement requirement (a measurement requirement specified in a protocol) may further be introduced for the terminal device to require the terminal device to perform the measurement for the neighbouring cell of at least one of the intra-frequency, the inter-frequency, or the inter-system supporting the target service based on the new measurement requirement. For example, the terminal device may be required to perform more frequently the measurement for a cell on a frequency of at least one of the intra-frequency, the inter-frequency, or the inter-system in order to find out the cell supporting the target service as soon as possible, so that when the cell of at least one of the intra-frequency, the inter-frequency, or the inter-system fulfils a threshold of signal quality, the terminal device may camp on the cell at once, so as to subsequently transmit the target service.

If the serving cell where the terminal device currently camps supports the target service, the terminal device may perform the relaxed measurement for the intra-frequency neighbouring cell or not perform the measurement for the intra-frequency neighbouring cell for the period of time. The terminal device may learn whether the cell supporting the target service is in the intra-frequency neighbouring cell of the serving cell where the terminal device camps from frequency information for supporting the target service, location area information for supporting the target service, or a cell identifier for the cell supporting the target service indicated in a system information or a dedicated signalling sent by the serving cell. The dedicated signalling may be an RRC release message. When the terminal device does not camp on the cell supporting the target service, the terminal device performs the normal measurement for the intra-frequency neighbouring cell that may support the target service.

In the embodiment of the present disclosure, when the terminal device in the idle state or the inactive state fulfils the low mobility criterion, the approach for measuring the neighbouring cell of at least one of the intra-frequency, the inter-frequency, or the inter-system may be determined based on whether the serving cell supports the target service, so as to enable the neighbouring cell supporting the target service to be measured preferentially, so that the terminal device can preferentially reselect the cell supporting the target service, and a service requirement of the terminal device can be fulfilled.

### Embodiment 2

Reference is made to FIG. 4, where FIG. 4 is a schematic flowchart of a method for neighbouring cell measurement provided in another embodiment of the present disclosure, and the method is applied to a communication system illustrated in FIG. 1. As illustrated in FIG. 4, the method includes the following operations.

At block S410, a terminal device receives a first message from a serving cell, where the first message is used to configure a relaxed measurement criterion, and the relaxed measurement criterion includes a not-at-cell-edge criterion.

The first message may be an SIB2 message. The terminal device is in an RRC inactive state or an RRC idle state. The serving cell where the terminal device camps may configure the not-at-cell-edge criterion via the SIB2 message. Upon determining that the terminal device fulfils the relaxed measurement criterion, the terminal device may determine an approach for measuring an inter-frequency neighbouring cell and/or an inter-system neighbouring cell.

At block S420, when the terminal device fulfils the not-at-cell-edge criterion and the serving cell does not support a target service, the terminal device performs a measurement for a first cell of at least one of an intra-frequency, an inter-frequency, or an inter-system or performs the measurement for the first cell of at least one of the intra-frequency, the inter-frequency, or the inter-system after adjusting a measurement parameter. When the terminal device fulfils the not-at-cell-edge criterion and the serving cell supports the target service, the terminal device performs a relaxed measurement for the first cell of at least one of the intra-frequency, the inter-frequency, or the inter-system. The first cell is a neighbouring cell supporting the target service.

In the embodiment of the present disclosure, the target service may be an intended slice, and each slice corresponds to a service type. The target service may be a service that the terminal device expects to establish in the future, which may include a high-definition voice service, a high-definition video service, a low-delay service, and a low-delay high-reliability service, etc.

Exemplarily, the first cell may further be a cell supporting a multicast service and expected to be accessed by the terminal device, or a closed-mode cell being a member and expected to be accessed by the terminal device. In case where the terminal device needs to preferentially access these cells, if the terminal device currently fulfils the relaxed measurement criterion, for the cell supporting the multicast service or the closed-mode cell being the member, the terminal device may perform the measurement with the method described above, so as to camp on these cells as soon as possible.

It is noted that the first cell may further be a cell expected to be accessed by the terminal device in other application scenarios, or a cell that supports other desired services, which is not limited in the embodiment of the present disclosure.

In the embodiment of the present disclosure, the not-at-cell-edge criterion is configured in the SIB2 sent by the serving cell, and a low mobility criterion is not configured in the SIB2 sent by the serving cell. For the terminal device in the idle state or in the inactive state, when the serving cell fulfils Srxlev>S_{SearchThresholdP} (i.e. the terminal device fulfils the not-at-cell-edge criterion), if the serving cell where the terminal device camps does not supports the target service but an intra-frequency neighbouring cell supports the target service, the terminal device may perform a normal measurement for the intra-frequency neighbouring cell supporting the target service (i.e. the relaxed measurement is not performed) in order to camp on the cell supporting the target service. If the serving cell where the terminal device currently camps supports the target service, the terminal device may perform the relaxed measurement for the intra-frequency neighbouring cell or not perform the measurement for the intra-frequency neighbouring cell for a period of time, so as to reduce power consumption.

For the terminal device in the idle state or in the inactive state, when the serving cell fulfils Srxlev≤S_{nonIntraSearchp} or Squal≤S_{nonIntraSearchQ}, and the terminal device fulfils the not-at-cell-edge criterion, if the serving cell where the terminal device camps does not support the target service but the inter-frequency neighbouring cell and/or the inter-system neighbouring cell supports the target service, the terminal device may perform the normal measurement for the inter-frequency neighbouring cell and/or the inter-system neighbouring cell supporting the target service (i.e. the relaxed measurement is not performed) in order to camp on the cell supporting the target service. If the serving cell where the terminal device currently camps supports the target service, the terminal device may perform the relaxed measurement for the inter-frequency neighbouring cell and/or the inter-system neighbouring cell or not perform the measurement for the inter-frequency neighbouring cell and/or the inter-system neighbouring cell for the period of time, so as to reduce power consumption.

Further, when the serving cell where the terminal device currently camps supports the target service, the inter-frequency neighbouring cell and/or the inter-system neighbouring cell also supports the target service, and a priority of the target service supported by the inter-frequency neighbouring cell and/or the inter-system neighbouring cell is higher than a priority of the target service supported by the serving cell where the terminal device currently camps, the terminal device may perform the normal measurement for the inter-frequency neighbouring cell and/or the inter-system neighbouring cell, in order to find out the cell supporting the target service with a higher priority as soon as possible, so as to subsequently transmit the target service.

Exemplarily, a new measurement requirement (a measurement requirement specified in a protocol) may further be introduced for the terminal device to require the terminal device to perform the measurement for the inter-frequency neighbouring cell and/or the inter-system neighbouring cell supporting the target service based on the new measurement requirement. For example, the terminal device may be required to perform more frequently the measurement for a cell on a frequency of the inter-frequency and/or the inter-system in order to find out the cell supporting the target service as soon as possible, so that when the cell of the inter-frequency and/or the inter-system fulfils a threshold of signal quality, the terminal device may camp on the cell at once, so as to subsequently transmit the target service.

If the serving cell where the terminal device currently camps supports the target service, the terminal device may perform the relaxed measurement for the inter-frequency neighbouring cell and/or the inter-system neighbouring cell. The terminal device may learn whether the cell supporting the target service is in the inter-frequency neighbouring cell and/or the inter-system neighbouring cell of the serving cell where the terminal device camps from frequency information for supporting the target service, location area information for supporting the target service, or a cell identifier for the cell supporting the target service indicated in system information or a dedicated signalling sent by the serving cell. The dedicated signalling may be an RRC release message. If the terminal device does not camp on the cell supporting the target service, the terminal device performs the normal measurement for the inter-frequency neighbouring cell and/or the inter-system neighbouring cell that may support the target service.

In the embodiment of the present disclosure, when the terminal device in the idle state or the inactive state fulfils the not-at-cell-edge criterion, the approach for measuring the neighbouring cell of at least one of the intra-frequency, the inter-frequency, or the inter-system may be determined based on whether the serving cell supports the target service, so as to enable the neighbouring cell supporting the target service to be measured preferentially, so that the terminal device can preferentially reselect the cell supporting the target service, and a service requirement of the terminal device can be fulfilled.

### Embodiment 3

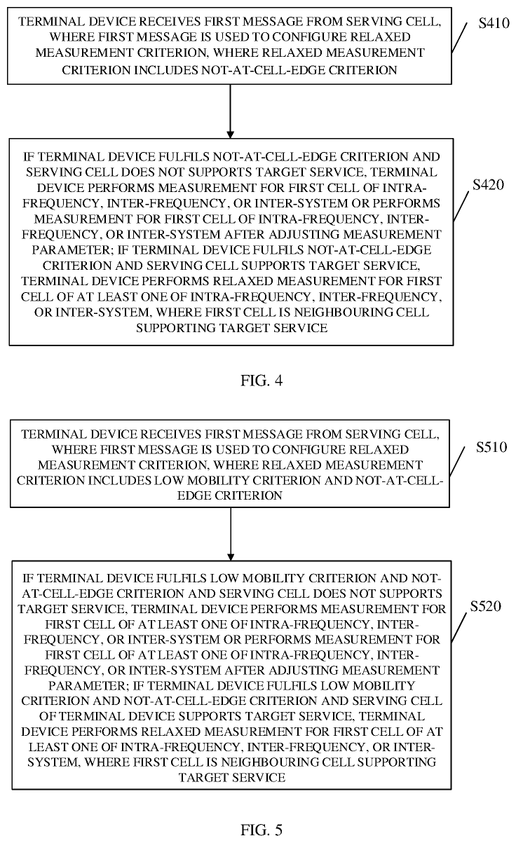

Reference is made to FIG. 5, where FIG. 5 is a schematic flowchart of a method for neighbouring cell measurement provided in another embodiment of the present disclosure, and the method is applied to a communication system illustrated in FIG. 1. As illustrated in FIG. 5, the method includes the following operations.

At block S510, a terminal device receives a first message from a serving cell, where the first message is used to configure a relaxed measurement criterion, and the relaxed measurement criterion includes a low mobility criterion and a not-at-cell-edge criterion.

The first message may be an SIB2 message. The terminal device is in an RRC inactive state or an RRC idle state. The serving cell where the terminal device camps may configure the low mobility criterion via the SIB2 message. Upon determining the terminal device fulfils the relaxed measurement criterion, the terminal device may determine an approach for measuring an intra-frequency neighbouring cell.

At block S520, if the terminal device fulfils the low mobility criterion and the not-at-cell-edge criterion, and the serving cell does not support a target service, the terminal device performs a measurement for a first cell of at least one of an intra-frequency, an inter-frequency, or an inter-system or performs the measurement for the first cell of at least one of the intra-frequency, the inter-frequency, or the inter-system after adjusting a measurement parameter. If the terminal device fulfils the low mobility criterion and the not-at-cell-edge criterion, and the serving cell where the terminal device camps supports the target service, the terminal device performs a relaxed measurement for the first cell of at least one of the intra-frequency, the inter-frequency, or the inter-system. The first cell is a neighbouring cell supporting the target service.

In the embodiment of the present disclosure, the target service may be an intended slice, and each slice corresponds to a service type. The target service may be a service that the terminal device expects to establish in the future, which may include a high-definition voice service, a high-definition video service, a low-delay service, and a low-delay high-reliability service, etc.

Exemplarily, the first cell may further be a cell supporting a multicast service and expected to be accessed by the terminal device, or a closed-mode cell being a member and expected to be accessed by the terminal device. In case where the terminal device needs to preferentially access these cells, if the terminal device currently fulfils the relaxed measurement criterion, for the cell supporting the multicast service or the closed-mode cell being the member, the terminal device may perform the measurement with the method described above, so as to camp on these cells as soon as possible.

It is noted that the first cell may further be a cell expected to be accessed by the terminal device in other application scenarios, or a cell that supports other desired services, which is not limited in the embodiment of the present disclosure.

The low mobility criterion (lowMobilityEvaluation) and the not-at-cell-edge criterion are configured in the SIB2 sent by the serving cell. For the terminal device in the idle state or in the inactive state, when the terminal device has normally performed the measurement for at least one of the intra-frequency, the inter-frequency, or the inter-system for at least T_{SearchDeltaP} after reselecting a new cell with Srxlev>S_{SearchThresholdP} and (Srxlev_{Ref}−Srxlev)<S_{SearchDeltaP}, or the terminal device has normally performed the measurement for at least one of the intra-frequency, the inter-frequency, or the inter-system for at least T_{SearchDeltaP} after reselecting a new cell with Srxlev>S_{SearchThresholdP} and (Srxlev_{Ref}−Srxlev)<S_{SearchDeltaP} but combineRelaxedMeasCondition is not configured, if the serving cell where the terminal device currently camps does not support the target service but the neighbouring cell of at least one of the intra-frequency, the inter-frequency, or the inter-system supports the target service, the terminal device may perform a normal measurement for the neighbouring cell of at least one of the intra-frequency, the inter-frequency, or the inter-system supporting the target service (i.e. the relaxed measurement is not performed), in order to camp on the cell supporting the target service. If the serving cell where the terminal device currently camps supports the target service, the terminal device may perform the relaxed measurement for the neighbouring cell of at least one of the intra-frequency, the inter-frequency, or the inter-system or not perform the measurement for the neighbouring cell of at least one of the intra-frequency, the inter-frequency, or the inter-system for a period of time, so as to reduce power consumption.

For the terminal device in the idle state or in the inactive state, when the serving cell fulfills Srxlev≤S_{nonIntraSearchP} or Squal≤S_{nonIntraSearchQ}, if the serving cell where the terminal device currently camps does not supports the target service but an inter-frequency neighbouring cell and/or an inter-system neighbouring cell support the target service, the terminal device may perform the normal measurement for the inter-frequency neighbouring cell and/or the inter-system neighbouring cell supporting the target service (i.e. the relaxed measurement is not performed) in order to camp on the cell supporting the target service. If the serving cell where the terminal device currently camps supports the target service, the terminal device may perform the relaxed measurement for the inter-frequency neighbouring cell and/or the inter-system neighbouring cell or not perform the measurement for the inter-frequency neighbouring cell and/or the inter-system neighbouring cell for the period of time, so as to reduce power consumption.

Further, when the serving cell where the terminal device currently camps supports the target service, the inter-frequency neighbouring cell and/or the inter-system neighbouring cell also supports the target service, and a priority of the target service supported by the inter-frequency neighbouring cell and/or the inter-system neighbouring cell is higher than a priority of the target service supported by the serving cell where the terminal device currently camps, the terminal device may perform the normal measurement for the inter-frequency neighbouring cell and/or the inter-system neighbouring cell, in order to find out the cell supporting the target service with a higher priority as soon as possible, so as to subsequently transmit the target service.

Exemplarily, a new measurement requirement (a measurement requirement specified in a protocol) may further be introduced for the terminal device to require the terminal device to perform the measurement for the inter-frequency neighbouring cell and/or the inter-system neighbouring cell supporting the target service based on the new measurement requirement. For example, the terminal device may be required to perform more frequently the measurement for a cell on a frequency of the inter-frequency and/or the inter-system in order to find out the cell supporting the target service as soon as possible, so that when the cell of the inter-frequency and/or the inter-system fulfils a threshold of signal quality, the terminal device may camp on the cell at once, so as to subsequently transmit the target service.

If the serving cell where the terminal device currently camps supports the target service, the terminal device may perform the relaxed measurement for the intra-frequency neighbouring cell. The terminal device may learn whether the cell supporting the target service is in the intra-frequency neighbouring cell of the serving cell where the terminal device camps from frequency information for supporting the target service, location area information for supporting the target service, or a cell identifier for the cell supporting the target service indicated in system information or a dedicated signalling sent by the serving cell. The dedicated signalling may be an RRC release message. If the terminal device does not camp on the cell supporting the target service, the terminal device performs the normal measurement for the intra-frequency neighbouring cell that may support the target service.

In the embodiment of the present disclosure, when the terminal device fulfils the low mobility criterion and the not-at-cell-edge criterion, the approach for measuring the neighbouring cell of at least one of the intra-frequency, the inter-frequency, or the inter-system may be determined based on whether the serving cell supports the target service, so as to enable the neighbouring cell supporting the target service to be measured preferentially, so that the terminal device can preferentially reselect the cell supporting the target service, and a service requirement of the terminal device can be fulfilled.

### Embodiment 4

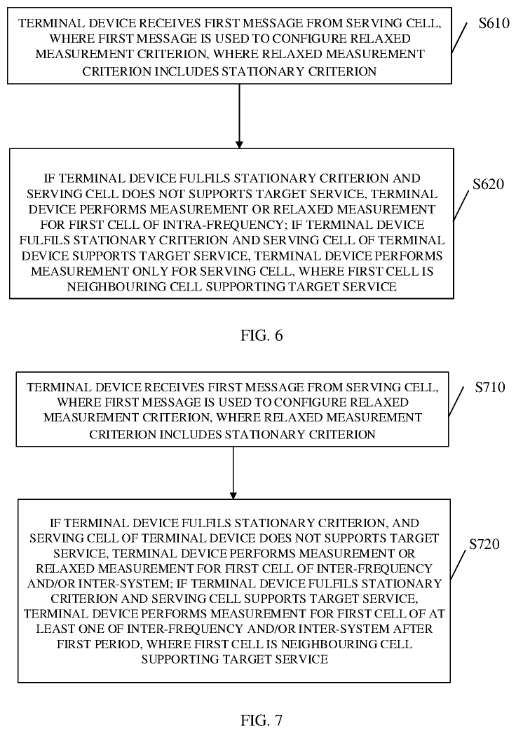

Reference is made to FIG. 6, where FIG. 6 is a schematic flowchart of a method for neighbouring cell measurement provided in another embodiment of the present disclosure, and the method is applied to a communication system illustrated in FIG. 1. As illustrated in FIG. 6, the method includes the following operations.

At block S610, a terminal device receives a first message from a serving cell, where the first message is used to configure a relaxed measurement criterion, and the relaxed measurement criterion includes a stationary criterion.

The first message may be an SIB2 message. The terminal device is in a stationary state. The serving cell where the terminal device camps may configure the stationary criterion via the SIB2 message. Upon determining the terminal device fulfils the relaxed measurement criterion, the terminal device may determine an approach for measuring an intra-frequency neighbouring cell.

At block S620, if the terminal device fulfilling the stationary criterion and the serving cell does not support the target service, the terminal device performs a measurement or a relaxed measurement for a first cell of an intra-frequency. If the terminal device fulfils the stationary criterion and the serving cell of the terminal device supports the target service, the terminal device performs the measurement only for the serving cell. The first cell is a neighbouring cell supporting the target service.

In the embodiment of the present disclosure, the target service may be an intended slice, and each slice corresponds to a service type. The target service may be a service that the terminal device expects to establish in the future, which may include a high-definition voice service, a high-definition video service, a low-delay service, and a low-delay high-reliability service, etc.

Exemplarily, the first cell may further be a cell supporting a multicast service and expected to be accessed by the terminal device, or a closed-mode cell being a member and expected to be accessed by the terminal device. In case where the terminal device needs to preferentially access these cells, if the terminal device currently fulfils the relaxed measurement criterion, for the cell supporting the multicast service or the closed-mode cell being the member, the terminal device may perform the measurement with the method described above, so as to camp on these cells as soon as possible.

It is noted that the first cell may further be a cell expected to be accessed by the terminal device in other application scenarios, or a cell that supports other desired services, which is not limited in the embodiment of the present disclosure.

In the embodiment of the present disclosure, the stationary criterion is configured in the SIB2 sent by the serving cell. For the terminal device in the stationary state, if the serving cell where the terminal device currently camps does not support the target service but the intra-frequency neighbouring cell supports the target service, the terminal device may perform the measurement or the relaxed measurement for the intra-frequency neighbouring cell supporting the target service in order to camp on the cell supporting the target service. If the serving cell where the terminal device currently camps supports the target service, the terminal device may perform the measurement only for the serving cell and does not perform the measurement for the intra-frequency neighbouring cell, so as to reduce power consumption.

If the terminal device does not camp on the cell supporting the target service, the terminal device performs the measurement or the relaxed measurement for the intra-frequency neighbouring cell. The terminal device may learn whether the cell supporting the target service is in the intra-frequency neighbouring cell of the serving cell where the terminal device camps from frequency information for supporting the target service, location area information for supporting the target service, or a cell identifier for the cell supporting the target service indicated in system information or a dedicated signalling sent by the serving cell. The dedicated signalling may be an RRC release message. If the terminal device camps on the cell supporting the target service, the terminal device performs the measurement only for the serving cell and does not perform the measurement for the intra-frequency neighbouring cell supporting the target service.

In the embodiment of the present disclosure, for the terminal device in the stationary state, the approach for measuring the intra-frequency neighbouring cell may be determined based on whether the serving cell supports the target service, so as to enable the neighbouring cell supporting the target service to be measured preferentially, so that the terminal device can preferentially reselect the cell supporting the target service, and a service requirement of the terminal device can be fulfilled.

### Embodiment 5

Reference is made to FIG. 7, where FIG. 7 is a schematic flowchart of a method for neighbouring cell measurement provided in another embodiment of the present disclosure, and the method is applied to a communication system illustrated in FIG. 1. As illustrated in FIG. 7, the method includes the following operations.

At block S710, a terminal device receives a first message from a serving cell, where the first message is used to configure a relaxed measurement criterion, and the relaxed measurement criterion includes a stationary criterion.

The first message may be an SIB2 message. The terminal device is in a stationary state. The serving cell where the terminal device camps may configure the stationary criterion via the SIB2 message. Upon determining the terminal device fulfils the relaxed measurement criterion, the terminal device may determine an approach for measuring an inter-frequency neighbouring cell and/or an inter-system neighbouring cell.

At block S720, if the terminal device fulfils the stationary criterion, and the serving cell of the terminal device does not support a target service, the terminal device performs a measurement or a relaxed measurement for a first cell of an inter-frequency and/or an inter-system. If the terminal device fulfils the stationary criterion, and the serving cell supports the target service, the terminal device performs the measurement for the first cell of at least one of the inter-frequency and/or the inter-system after a first period. The first cell is a neighbouring cell supporting the target service.

In the embodiment of the present disclosure, the target service may be an intended slice, and each slice corresponds to a service type. The target service may be a service that the terminal device expects to establish in the future, which may include a high-definition voice service, a high-definition video service, a low-delay service, and a low-delay high-reliability service, etc.

Exemplarily, the first cell may further be a cell supporting a multicast service and expected to be accessed by the terminal device, or a closed-mode cell being a member and expected to be accessed by the terminal device. In case where the terminal device needs to preferentially access these cells, if the terminal device currently fulfils the relaxed measurement criterion, for the cell supporting the multicast service or the closed-mode cell being the member, the terminal device may perform the measurement with the method described above, so as to camp on these cells as soon as possible.

It is noted that the first cell may further be a cell expected to be accessed by the terminal device in other application scenarios, or a cell that supports other desired services, which is not limited in the embodiment of the present disclosure.

In the embodiment of the present disclosure, the stationary criterion is configured in the SIB2 sent by the serving cell. For the terminal device in the stationary state, if the serving cell where the terminal device currently camps does not support the target service but the inter-frequency neighbouring cell and/or the inter-system neighbouring cell supports the target service, the terminal device may perform the measurement or the relaxed measurement for the inter-frequency neighbouring cell and/or the inter-system neighbouring cell, in order to camp on the cell supporting the target service. If the serving cell where the terminal device currently camps supports the target service, the terminal device may not perform the measurement for the inter-frequency neighbouring cell and/or the inter-system neighbouring cell for a period of time and perform the measurement for the inter-frequency neighbouring cell and/or the inter-system neighbouring cell after the period of time, so as to reduce power consumption. In other words, for the terminal device in the stationary state, if the serving cell where the terminal device currently camps supports the target service, the terminal device needs to perform at least one measurement for the inter-frequency neighbouring cell and/or the inter-system neighbouring cell every period of time (e.g. 1 hour) and the terminal device may not perform the measurement for the frequency within 1 hour after the measurement was last performed.

If the terminal device does not camp on the cell supporting the target service, the terminal device performs the measurement or the relaxed measurement for the inter-frequency neighbouring cell and/or the inter-system neighbouring cell. The terminal device may learn whether the cell supporting the target service is in the inter-frequency neighbouring cell and/or the inter-system neighbouring cell of the serving cell where the terminal device camps from frequency information for supporting the target service, location area information for supporting the target service, or a cell identifier for the cell supporting the target service indicated in system information or a dedicated signalling sent by the serving cell. The dedicated signalling may be an RRC release message.

In the embodiment of the present disclosure, for the terminal device in the stationary state, the approach for measuring the inter-frequency neighbouring cell and/or the inter-system neighbouring cell may be determined based on whether the serving cell supports the target service, so as to enable the neighbouring cell supporting the target service to be measured preferentially, so that the terminal device can preferentially reselect the cell supporting the target service, and a service requirement of the terminal device can be fulfilled.

### Embodiment 6

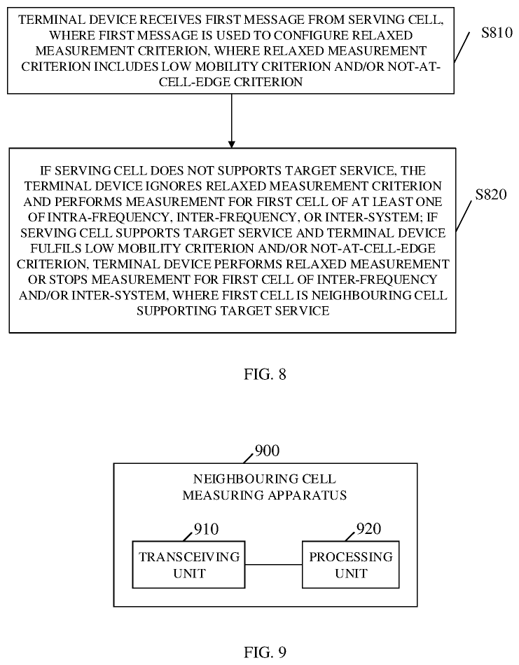

Reference is made to FIG. 8, where FIG. 8 is a schematic flowchart of a method for neighbouring cell measurement provided in another embodiment of the present disclosure, and the method is applied to a communication system illustrated in FIG. 1. As illustrated in FIG. 8, the method includes the following operations.

At block S810, a terminal device receives a first message from a serving cell, where the first message is used to configure a relaxed measurement criterion, and the relaxed measurement criterion includes a low mobility criterion and/or a not-at-cell-edge criterion.

The first message may be an SIB2 message. The terminal device is in an RRC inactive state or an RRC idle state. The serving cell where the terminal device camps may configure the low mobility criterion via the SIB2 message. Upon determining the terminal device fulfils the relaxed measurement criterion, the terminal device may determine an approach for measuring an intra-frequency neighbouring cell.

At block S820, when the serving cell does not support a target service, the terminal device ignores the relaxed measurement criterion and performs a measurement for a first cell of at least one of an intra-frequency, an inter-frequency, or an inter-system. When the serving cell supports the target service and the terminal device fulfils the low mobility criterion and/or the not-at-cell-edge criterion, the terminal device performs a relaxed measurement or stops the measurement for the first cell of the inter-frequency and/or the inter-system. The first cell is a neighbouring cell supporting the target service.

The target service includes any one of: one or more slice services, a multicast service, or a service established in a closed-mode cell.

In the embodiment of the present disclosure, the target service may be an intended slice, and each slice corresponds to a service type. The target service may be a service that the terminal device expects to establish in the future, which may include a high-definition voice service, a high-definition video service, a low-delay service, and a low-delay high-reliability service, etc. The target service may also be the multicast service expected to be accessed by the terminal device, or the service developed in the closed-mode cell expected to be accessed by the terminal device.

Exemplarily, the first cell may further be a cell supporting the multicast service and expected to be accessed by the terminal device, or a closed-mode cell being a member and expected to be accessed by the terminal device. In case where the terminal device needs to preferentially access these cells, if the terminal device currently fulfils the relaxed measurement criterion, for the cell supporting the multicast service or the closed-mode cell being the member, the terminal device may perform the measurement with the method described above, so as to camp on these cells as soon as possible.

It is noted that the first cell may further be a cell expected to be accessed by the terminal device in other application scenarios, or a cell that supports other desired services, which is not limited in the embodiment of the present disclosure.

In the embodiment of the present disclosure, when the serving cell where the terminal device camps does not support the target service, the terminal device may ignore the received relaxed measurement criterion and perform a normal measurement for the intra-frequency neighbouring cell, the inter-frequency neighbouring cell, and/or the inter-system neighbouring cell as specified in a criterion, in order to camp on the cell supporting the target service.

Further, the low mobility criterion (lowMobilityEvaluation) and/or the not-at-cell-edge criterion are configured in the SIB2 sent by the serving cell. For the terminal device in the idle state or in the inactive state, when the serving cell fulfils Srxlev>S_{SearchThresholdP} (i.e. the terminal device fulfils the not-at-cell-edge criterion), or the terminal device has performed the measurement for the intra-frequency for at least T_{SearchDeltaP} after (re-)selecting a new cell and the serving cell fulfils (Srxlev_{Ref}−Srxlev)<S_{SearchDeltaP} (i.e. the terminal device fulfils the low mobility criterion), or the terminal device has normally performed the measurement for at least one of the inter-frequency and/or the inter-system for at least T_{SearchDeltaP} after reselecting a new cell with Srxlev>S_{SearchThresholdP} and (Srxlev_{Ref}−Srxlev)<S_{SearchDeltaP}, if the serving cell where the terminal device camps does not supports the target service but the neighbouring cell of the inter-frequency and/or the inter-system supports the target service, the terminal device may perform the normal measurement for the neighbouring cell of the inter-frequency and/or the inter-system supporting the target service (i.e. the relaxed measurement is not performed). If the serving cell where the terminal device currently camps supports the target service, the terminal device may perform the relaxed measurement for the neighbouring cell of the inter-frequency and/or the inter-system or not perform the measurement for the neighbouring cell of the inter-frequency and/or the inter-system for a period of time, so as to reduce power consumption.

If the serving cell where the terminal device currently camps supports the target service, the terminal device may perform the relaxed measurement for the inter-frequency neighbouring cell and/or the inter-system neighbouring cell or not perform the measurement for the inter-frequency neighbouring cell and/or the inter-system neighbouring cell for the period of time. The terminal device may learn whether the cell supporting the target service is in the inter-frequency neighbouring cell and/or the inter-system neighbouring cell of the serving cell where the terminal device camps from frequency information for supporting the target service, location area information for supporting the target service, or a cell identifier for the cell supporting the target service indicated in system information or a dedicated signalling sent by the serving cell. The dedicated signalling may be an RRC release message. When the terminal device does not camp on the cell supporting the target service, the terminal device may ignore the relaxed measurement criterion and perform the normal measurement for the intra-frequency neighbouring cell that may support the target service.

In the embodiment of the present disclosure, the terminal device in the idle state or the inactive state may ignore the relaxed measurement criterion when the serving cell where the terminal device camps does not support the target service, or the terminal device may perform the relaxed measurement or stop the measurement for the neighbouring cell of the inter-frequency and/or the inter-system when the serving cell where the terminal device camps supports the target service, so as to enable the neighbouring cell supporting the target service to be measured preferentially, so that the terminal device can preferentially reselect the cell supporting the target service, and a service requirement of the terminal device can be fulfilled.

The foregoing solution of the embodiments of the disclosure is mainly described from the viewpoint of the method implementation. It can be understood that, in order to implement the above functions, the network device includes hardware structures and/or software modules for performing the respective functions. Those skilled in the art should readily recognize that, in combination with the units and algorithmic operations of various examples described in the embodiments disclosed herein, the present disclosure can be implemented in hardware or a combination of the hardware and computer software. Whether a function is implemented by way of the hardware or hardware driven by the computer software depends on the particular application and design constraints of the technical solution. Those skilled in the art may use different methods to implement the described functions for each particular application, but such embodiment should not be considered as beyond the scope of the present disclosure.

Reference is made to FIG. 9, where FIG. 9 is a block diagram illustrating functional units of an apparatus for neighbouring cell measurement provided in an embodiment of the present disclosure. The apparatus 900 is applied to a terminal device and includes a transceiving unit 910 and a processing unit 920.

The transceiving unit 910 is configured to receive a first message from a serving cell, where the first message is used to configure a relaxed measurement criterion.

The processing unit 920 is configured to perform a measurement for a first frequency corresponding to a first cell based on the first message, and the first cell is a neighbouring cell supporting a target service.

Optionally, the relaxed measurement criterion includes at least one of a low mobility criterion, a not-at-cell-edge criterion, or a stationary criterion.

Optionally, in terms of performing the measurement for the first cell based on the first message, the processing unit 920 is specifically configured to perform the measurement for the first cell of at least one of an intra-frequency, an inter-frequency, or an inter-system or perform the measurement for the first cell of at least one of an intra-frequency, an inter-frequency, or an inter-system after adjusting a measurement parameter when the terminal device fulfils the low mobility criterion and/or the not-at-cell-edge criterion and the serving cell does not support the target service, or the processing unit 920 is specifically configured to perform a relaxed measurement for the first cell of the intra-frequency when the terminal device fulfils the low mobility criterion and/or the not-at-cell-edge criterion and the serving cell supports the target service.

Optionally, the processing unit 920 is further configured to perform any one of the measurement, the measurement after adjusting the measurement parameter, or ignoring the relaxed measurement criterion for the first cell of the inter-frequency and/or the inter-system when a priority of the target service supported by the serving cell is lower than a priority of the target service supported by the first cell.

Optionally, in terms of performing the measurement for the first cell based on the first message, the processing unit 920 is specifically configured to enable the terminal device to perform any one of the measurement, the measurement after adjusting the measurement parameter, or the relaxed measurement for the first cell of at least one of the intra-frequency, the inter-frequency, or the inter-system when the serving cell does not support the target service.

Optionally, in terms of performing the measurement for the first cell based on the first message, the processing unit 920 is specifically configured to perform the measurement or the relaxed measurement for the first cell of the intra-frequency when the terminal device fulfils the low mobility criterion and the serving cell does not support the target service, or the processing unit 920 is specifically configured to perform the measurement only for the serving cell when the terminal device fulfils the low mobility criterion and/or the not-at-cell-edge criterion and the serving cell of the terminal device supports the target service.

Optionally, in terms of performing the measurement for the first cell based on the first message, the processing unit 920 is specifically configured to perform the measurement or the relaxed measurement for the first cell of the inter-frequency and/or the inter-system when the terminal device fulfils the low mobility criterion and the serving cell of the terminal device does not support the target service, or the processing unit 920 is specifically configured to perform the measurement for the first cell of the inter-frequency and/or the inter-system after a first period when the terminal device fulfils the low mobility criterion and/or the not-at-cell-edge criterion and the serving cell of the terminal device supports the target service.

Optionally, the terminal device is in an RRC inactive state or an RRC idle state.

Optionally, the terminal device is in a stationary state.

Optionally, the transceiving unit 910 is further configured to receive a second message from the serving cell, and the second message indicates whether the terminal device performs the relaxed measurement.

The processing unit 920 is further configured to perform the measurement for the neighbouring cell supporting the target service or perform the measurement for the neighbouring cell supporting the target service after adjusting the measurement parameter when the second message indicates that the terminal device does not perform the relaxed measurement.

Optionally, the transceiving unit 910 is further configured to receive a third message from the serving cell, and the third message indicates at least one of frequency information, location area information, or a cell identifier for supporting the target service.

The processing unit 920 is further configured to determine the first cell based on the third message.

It is understood that the apparatus 900 takes the form of a functional unit. The term “unit” herein can refer to application specific integrated circuits (ASICs), electronic circuits, processors (e.g., shared processors, dedicated processors, or group processors, etc.) and memories for executing one or more software or firmware programs, combinational logic circuits, and/or other suitable components that support the described functionality. In an optional example, those skilled in the art may understand that the apparatus 900 may specifically be the terminal device in the foregoing embodiments, and the apparatus 900 may be configured to execute each process and/or operation corresponding to the terminal device in the foregoing method embodiment, which is not described herein to avoid repetition.

The apparatus 900 in each of the foregoing solutions has a function of implementing corresponding operation executed by the terminal device in the foregoing method. The function may be implemented by hardware or by hardware executing corresponding software. The hardware or software may include one or more modules corresponding to the above function. For example, the transceiving unit 910 may be replaced by a transmitter, and the processing unit 920 may be replaced by a processor, so as to execute the transceiving operations and the related processing operations in the method embodiments respectively.

In embodiments of the present disclosure, the apparatus 900 may further be a chip or a chip system, such as a system on chip (SoC). Correspondingly, a detecting unit may be a detecting circuit of the chip, which is not limited herein.

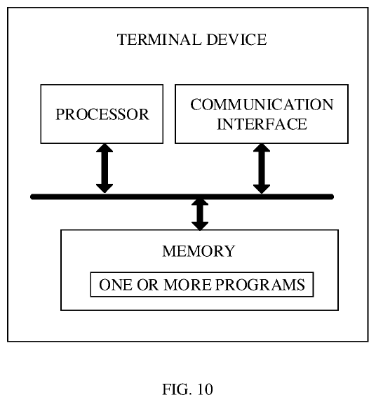

Reference is made to FIG. 10, where FIG. 10 is a schematic structural diagram of a terminal device provided in the embodiments of the present disclosure. The terminal device includes one or more processors, one or more memories, one or more communication interfaces, and one or more programs. The one or more programs are stored in the memory and configured to be executed by the one or more processors.

The foregoing programs includes instructions configured to perform the following operations.

A first message from a serving cell is received, where the first message is used to configure a relaxed measurement criterion.

A measurement is performed for a first frequency corresponding to a first cell based on the first message, where the first cell is a neighbouring cell supporting the target service.

For all the related contents of each scene involved in the described method embodiments, reference can be made to the functional description of the corresponding functional module, which will not be repeated herein.

It is understood that the foregoing memory may include a read-only memory and a random access memory and provide instructions and data for the processor. A portion of the memory may further include non-volatile random access memory. For example, the memory may further store information of a device type.

In the embodiments of the present disclosure, the processor of the foregoing apparatus may be a central processing unit (CPU), and the processor may further be another general processor, a digital signal processor (DSP), an application-specific integrated circuit (ASIC), a field programmable gate array (FPGA) or another programmable logic device, a discrete gate or transistor logic device, a discrete hardware component, or the like. The general processor may be a microprocessor, or the processor may further be any conventional processor, and so on.

It is understood that the term “at least one” involved in the embodiments of the present disclosure refers to one or more, and “a plurality of” refers to two or more. The term “and/or” describes an association relationship between associated objects representing that three relationships may exist. For example, A and/or B may represent the case where A exists separately, A and B exist simultaneously, and B exists separately, where A and B may be singular or plural. The character “/” generally represents a relationship of “or” between associated objects. The term “at least one of” or an analogous expression thereof refers to any combination of these items, including any combination of a singular item or a plural item. For example, at least one of a, b, or c may represent a, b, c, a-b, a-c, b-c, or a-b-c, where a, b, c may be a single or a plural.

Moreover, unless indicated to the contrary, the ordinal numbers such as “first” and “second” mentioned in the embodiments of the present disclosure are used for distinguishing multiple objects, and are not used for defining the order, timing, priority or importance degree of the multiple objects. For example, the first information and the second information are only used to differentiate different information, but do not indicate differences in content, priority, sending order, importance, or the like of the two types of information.

In implementation, each operation of the foregoing methods may be implemented by an integrated logic circuit of hardware in the processor or instructions in a software form. Operations in conjunction with the methods disclosed in the embodiments of the present disclosure may be directly implemented as being performed by a hardware processor, or being performed by a combination of hardware and software units in the processor. The software unit may be disposed in a mature storage medium in the art, such as a random access memory, a flash memory, a read-only memory, a programmable read-only memory, an electrically erasable programmable memory, and a register. The storage medium is disposed in a memory, and a processor executes instructions in the memory and performs the operations of the described method in combination with hardware thereof. To avoid repetition, the details will not be repeated herein.

A computer readable storage medium is further provided in the embodiments of the present disclosure. The computer readable storage medium is configured to store computer programs for electronic data interchange. The computer programs are operable with a computer to execute some or all of the operations of any method described in the foregoing method embodiments.

A computer program product is provided in embodiments of the present disclosure. The computer program product includes a non-transitory computer-readable storage medium that stores computer programs. The computer programs are operable with the computer to execute some or all of the operations of any method described in the foregoing method embodiments. The computer program product may be a software installation package.

For the sake of simplicity, the foregoing method embodiments are described as a series of action combinations. However, it will be appreciated by those skilled in the art that embodiments are not limited by the sequence of actions described. According to embodiments, some steps or operations may be performed in other orders or simultaneously. Besides, it will be appreciated by those skilled in the art that the embodiments described in the specification are exemplary embodiments, and the actions and modules involved are not necessarily essential to the disclosure.

In the foregoing embodiments, the description of each embodiment has its own emphasis. For the parts not described in detail in one embodiment, reference may be made to related descriptions in other embodiments.

It will be appreciated that the systems, apparatuses, and methods disclosed in embodiments herein may also be implemented in various other manners. For example, the above apparatus embodiments are merely illustrative, e.g., the division of units is only a division of logical functions, and there may exist other manners of division in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device or unit, and may be electrical, mechanical, or otherwise.

Separated units as illustrated may or may not be physically separated. Components or parts displayed as units may or may not be physical units, and may reside at one location or may be distributed to multiple networked units. Some or all of the units may be selectively adopted according to practical needs to achieve desired objectives of the disclosure.

Various functional units described in embodiments herein may be integrated into one processing unit or may be present as a number of physically separated units, and two or more units may be integrated into one. The integrated unit may take the form of hardware or a software functional unit.

If the integrated units are implemented as software functional units and sold or used as standalone products, they may be stored in a computer readable storage medium. Based on such an understanding, the essential technical solution, or the portion that contributes to the prior art, or all or part of the technical solution of the disclosure may be embodied as software products. The computer software products can be stored in a storage medium and may include multiple instructions that, when executed, can cause a computing device, e.g., a personal computer, a server, a network device, etc., or a processor to execute some or all operations of the methods described in various embodiments. The above storage medium may include various kinds of media that can store program codes, such as a universal serial bus (USB) flash disk, a mobile hard drive, a read-only memory (ROM), a random access memory (RAM), a magnetic disk, or an optical disk.

It will be understood by those of ordinary skill in the art that all or a part of the various methods of the embodiments described above may be accomplished by means of a program to instruct associated hardware, and the program may be stored in a computer-readable memory, which may include a flash disk, an ROM, an RAM, a magnetic disk, or an optical disk.

The above embodiments in the disclosure are described in detail. Principles and implementations of the disclosure are elaborated with specific implementations herein. The illustration of implementations above is only used to help understanding of methods and core ideas of the disclosure. At the same time, for those of ordinary skill in the art, according to ideas of the present disclosure, there will be changes in the specific implementations and application scopes. In summary, contents of this specification should not be understood as limitation on the present disclosure.

1. A method for neighbouring cell measurement, comprising:
receiving, by a terminal device, a first message from a serving cell, the first message being used to configure a relaxed measurement criterion; and
performing, by the terminal device, a measurement for a first frequency corresponding to a first cell, based on the first message, the first cell being a neighbouring cell supporting a target service.

2. The method of claim 1, wherein the relaxed measurement criterion comprises at least one of: a low mobility criterion, a not-at-cell-edge criterion, or a stationary criterion.

3. The method of claim 2, wherein performing, by the terminal device, a measurement for the first cell, based on the first message comprises:
in response to the terminal device fulfilling the low mobility criterion and/or the not-at-cell-edge criterion and the serving cell not supporting the target service, performing, by the terminal device, the measurement, or the measurement after adjusting a measurement parameter for the first cell of at least one of an intra-frequency, an inter-frequency, or an inter-system; and
in response to the terminal device fulfilling the low mobility criterion and/or the not-at-cell-edge criterion and the serving cell supporting the target service, performing, by the terminal device, a relaxed measurement for the first cell of at least one of the intra-frequency, the inter-frequency, or the inter-system.

4. The method of claim 3, wherein in response to a priority of the target service supported by the serving cell being lower than a priority of the target service supported by the first cell, the terminal device performs any one of the measurement, the measurement after adjusting a measurement parameter, or ignoring the relaxed measurement criterion for the first cell of any one of the intra-frequency, the inter-frequency, or the inter-system.

5. The method of claim 2, wherein performing, by the terminal device, a measurement for the first cell, based on the first message comprises:
in response to the serving cell not supporting the target service, ignoring, by the terminal device, the relaxed measurement criterion and performing, by the terminal device, the measurement for the first cell of at least one of an intra-frequency, an inter-frequency, or an inter-system; and
in response to the service cell supporting the target service and the terminal device fulfilling the low mobility criterion and/or the not-at-cell-edge criterion, performing, by the terminal device, a relaxed measurement or stopping, by the terminal device, the measurement for the first cell of an inter-frequency and/or an inter-system.

6. The method of claim 1, wherein performing, by the terminal device, a measurement for the first cell, based on the first message comprises:
in response to the serving cell not supporting the target service, performing, by the terminal device, any one of the measurement, the measurement after adjusting a measurement parameter, or a relaxed measurement for the first cell of at least one of an intra-frequency, an inter-frequency, or an inter-system.

7. The method of claim 2, wherein performing, by the terminal device, a measurement for the first cell, based on the first message comprises:
in response to the terminal device fulfilling the stationary criterion and the serving cell not supporting the target service, performing, by the terminal device, a measurement or a relaxed measurement for the first cell of an intra-frequency; and
in response to the terminal device fulfilling the stationary criterion and the serving cell of the terminal device supporting the target service, performing, by the terminal device, the measurement only for the serving cell.

8. The method of claim 2, wherein performing, by the terminal device, a measurement for the first cell, based on the first message comprises:
in response to the terminal device fulfilling the stationary criterion and the serving cell of the terminal device not supporting the target service, performing, by the terminal device, the measurement or a relaxed measurement for the first cell of an inter-frequency and/or an inter-system; and
in response to the terminal device fulfilling the stationary criterion and the serving cell of the terminal device supporting the target service, performing, by the terminal device, the measurement for the first cell of the inter-frequency and/or the inter-system after a first period.

9. The method of claim 1, wherein the terminal device is in a radio resource control (RRC) inactive state or an RRC idle state.

10. The method of claim 6, wherein the terminal device is in a stationary state.

11. The method of claim 1, wherein the target service comprises any one of: one or more slice services, a multicast service, or a service established in a closed-mode cell.

12. The method of claim 1, further comprising:
receiving, by the terminal device, a second message from the serving cell, the second message indicating whether the terminal device applies the relaxed measurement; and
performing, by the terminal device, a measurement, or a measurement after adjusting a measurement parameter for the neighbouring cell supporting the target service, in response to the second message indicating that the terminal device does not apply the relaxed measurement.

13. The method of claim 1, further comprising:
receiving, by the terminal device, a third message from the serving cell, the third message indicating at least one of frequency information, location area information, or a cell identifier for supporting the target service; and
determining, by the terminal device, the first cell, based on the third message.

14-18. (canceled)

19. A terminal device, comprising a processor, a memory, a communication interface, and one or more programs, the one or more programs being stored in the memory and configured to be executed by the processor, and the programs comprising instructions configured to perform;
receiving a first message from a serving cell, the first message being used to configure a relaxed measurement criterion; and
performing a measurement for a first frequency corresponding to a first cell, based on the first message, the first cell being a neighbouring cell supporting a target service.

20. A non-transitory computer-readable storage medium, configured to store computer programs for electronic-data interchange (EDI), the computer programs being configured to cause a computer to perform;
receiving a first message from a serving cell, the first message being used to configure a relaxed measurement criterion; and
performing a measurement for a first frequency corresponding to a first cell, based on the first message, the first cell being a neighbouring cell supporting a target service.

21. The terminal device of claim 19, wherein the relaxed measurement criterion comprises at least one of: a low mobility criterion, a not-at-cell-edge criterion, or a stationary criterion.

22. The method of claim 21, wherein in terms of performing, by the terminal device, a measurement for the first cell, based on the first message, the programs comprise instructions configured to perform:
in response to the terminal device fulfilling the low mobility criterion and/or the not-at-cell-edge criterion and the serving cell not supporting the target service, performing, by the terminal device, the measurement, or the measurement after adjusting a measurement parameter for the first cell of at least one of an intra-frequency, an inter-frequency, or an inter-system; and
in response to the terminal device fulfilling the low mobility criterion and/or the not-at-cell-edge criterion and the serving cell supporting the target service, performing, by the terminal device, a relaxed measurement for the first cell of at least one of the intra-frequency, the inter-frequency, or the inter-system.

23. The non-transitory computer-readable storage medium of claim 20, wherein the computer programs are further configured to cause the computer to perform:
receiving, by the terminal device, a second message from the serving cell, the second message indicating whether the terminal device applies the relaxed measurement; and
performing, by the terminal device, a measurement, or a measurement after adjusting a measurement parameter for the neighbouring cell supporting the target service, in response to the second message indicating that the terminal device does not apply the relaxed measurement.

24. The non-transitory computer-readable storage medium of claim 20, wherein the computer programs are further configured to cause the computer to perform:
receiving, by the terminal device, a third message from the serving cell, the third message indicating at least one of frequency information, location area information, or a cell identifier for supporting the target service; and
determining, by the terminal device, the first cell, based on the third message.
